(19) United States
(12) Patent Application Publication
(10) Pub. No.: US 2021/0189800 A1
(43) Pub. Date: Jun. 24, 2021

(54) SAFETY STOOL

(71) Applicant: THE SIMPLAY3 COMPANY, Streetsboro, OH (US)

(72) Inventor: John HRADISKY, Aurora, OH (US)

(21) Appl. No.: 16/719,353

(22) Filed: Dec. 18, 2019

(51) Int. Cl. E06C 7/18; A47C 12/00; A47D 1/00

(52) U.S. Cl. CPC E06C 7/181; E06C 7/185; A47D 1/004; A47C 12/00

(57) ABSTRACT

A child safety stool of adjustable height is provided to allow children to engage with vanities, cabinets, or other structures of varying heights. The stool will allow users, typically children, to reach, e.g., sinks, work surfaces, or kitchen counters to encourage hygiene and engagement with domestic activities or workshop projects. The stool is sturdy and has high sides to surround the user and aid balance while the user engages in activities.

This patent application claims priority to and the benefit of U.S. Provisional Patent Application Ser. No. 62/781,006 filed on Dec. 18, 2018, which is incorporated by reference herein in its entirety.

### FIELD

The present disclosure relates to stools for aiding access to raised structures such as cabinets or vanities.

### BACKGROUND

Interacting with elements of the world adapted for the average sized adult is often difficult for individuals of smaller stature, e.g., children. For instance, access to structures such as cabinets, tabletops, vanities, etc. is difficult given the relative height of their top surface as compared to a child.

Conventionally, various step stools or chairs have been used to allow children and shorter people access to the top surface of such structures. However, most conventional step stools and chairs leave users prone to injury, such as from contact with angled edges or from falls. Additionally, it is common for stools to be of a fixed height, and not configurable as a child grows, or adjustable for children of differing heights. These restrictions and others have resulted in a need for an improved stool system.

### SUMMARY

In accordance with one embodiment, the present embodiment relates to a stool. Specifically, one embodiment having a front section, a back section, and a standing platform, where the platform is adjustable.

In another embodiment, the stool is configured for two users.

The stool will allow users, typically children, to reach raised points of interest, e.g., sinks, work surfaces, or kitchen counters to encourage hygiene and engagement with activities such as domestic tasks or workshop projects. The stool is sturdy, and has high sides to surround the user and aid balance while the user engages in activities.

### BRIEF DESCRIPTION OF THE DRAWINGS

The following figures are included to illustrate certain aspects of the present disclosure, and should not be viewed as exclusive embodiments. The subject matter disclosed is capable of considerable modifications, alterations, combinations, and equivalents in form and function, as will occur to one of ordinary skill in the art and having the benefit of this disclosure.

FIG. 1 is a perspective view of a single user stool.

FIG. 2 is a front view of a single user stool.

FIG. 3 is a back view of a single user stool.

FIG. 4 is a left side view of a single user stool.

FIG. 5 is a right side view of a single user stool.

FIG. 6 is a bottom view of a single user stool.

FIG. 7 is a top view of a single user stool.

FIG. 8 is an exploded view of a single user stool from the front perspective.

FIG. 9 is an exploded view of a single user stool from the back perspective.

FIG. 10 is a front perspective view of a multi-user embodiment with a flip platform.

FIG. 11 is a front view of a multi-user embodiment with a flip platform.

FIG. 12 is a back view of a multi-user embodiment with a flip platform.

FIG. 13 is a side view of a multi-user embodiment with a flip platform.

FIG. 14 is an overhead view of one side of a multi-user embodiment with a flip platform.

FIG. 15 is an overhead view of one side of a multi-user embodiment with a flip platform.

FIG. 16 is a side view of a multi-user embodiment with a flip platform.

FIG. 17 is a front perspective view of a multi-user embodiment with individual platforms.

FIG. 18 is a front view of a multi-user embodiment with individual platforms.

FIG. 19 is a back view of a multi-user embodiment with individual platforms.

FIG. 20 is a side view of a multi-user embodiment with individual platforms.

FIG. 21 is a view of a platform in one embodiment at various stages of adjustment.

FIG. 22 shows parts of the stool in one embodiment.

FIG. 23 shows hardware for use in the assembly of one embodiment of the stool.

FIG. 24 shows assembly instructions for one embodiment of the stool.

FIG. 25 is a perspective view of one embodiment of the stool in use.

### DETAILED DESCRIPTION

The present disclosure provides a safety stool of adjustable height to provide a stepping stool to allow individuals of short stature to engage with vanities, cabinets, or other structures of varying heights. The stool will allow users, typically children, to reach raised points of interest, e.g., sinks, work surfaces, or kitchen counters to encourage hygiene and engagement with activities such as domestic tasks or workshop projects. The stool is sturdy, and has high sides to surround the user and aid balance while the user engages in activities.

The stool is constructed of one or more pieces of light weight, rigid material, e.g. plastic. In some embodiments, the material out of which the stool is constructed is durable, such as a double walled plastic. In some embodiments, the surface is blow molded, injection molded and/or rotationally molded plastic. In some embodiments, the material is inexpensive and the design simple so as to produce a more affordable stool.

According to some embodiments, the stool includes a front section, a back section, and a platform or standing platform. These sections may also be known as vertically extending walls. The front and back sections may have side walls that are integral to the front and back sections, or vertically extending walls. In some embodiments, the stool further comprises two or more arms that connect the front and back sections. In some embodiments, the front and back section are each comprised of one molded piece, in other embodiments the front and back sections are comprised of two or more connecting pieces. In some embodiments, the front and back sections are of a fixed width and consequently the side walls remain at a fixed distance from one another. In some embodiments, the front section has a step that may be used to step up to the standing platform. The step may be continuous with the front section, or may be a separate connecting piece. The front section may feature a top bar or rail that serves as a safety measure and balance aid, preventing a user from falling backward. The bar or rail may have indentations to allow a user to grip the rail, which indentations may also serve as a handle for the stool. The back section may have a back top bar, to similarly prevent a user tipping forward. In both cases, the bar may be of a height sufficient to prevent a small child or individual of short stature from falling over it, such as, for example about 18 inches or more from the platform. In other embodiments, the top bar is not provided, and instead there is open access to the counter or surface with which the stool is used in conjunction. In still other embodiments, the back section is a closed and continuous, or substantially continuous piece of material that provides for a solid or near solid back.

In some embodiments, the user may access the standing platform by crawling or bending under the top bar and righting themselves once on the other side. In other embodiments, the top bar may be removable, semi-detachable, or hinged. In some embodiments, the stool is reversible, and has front and back sides of differing heights, thus potentially accommodating differently sized counter heights. The stool may be easily maneuverable, thus readily rotating or changing positions.

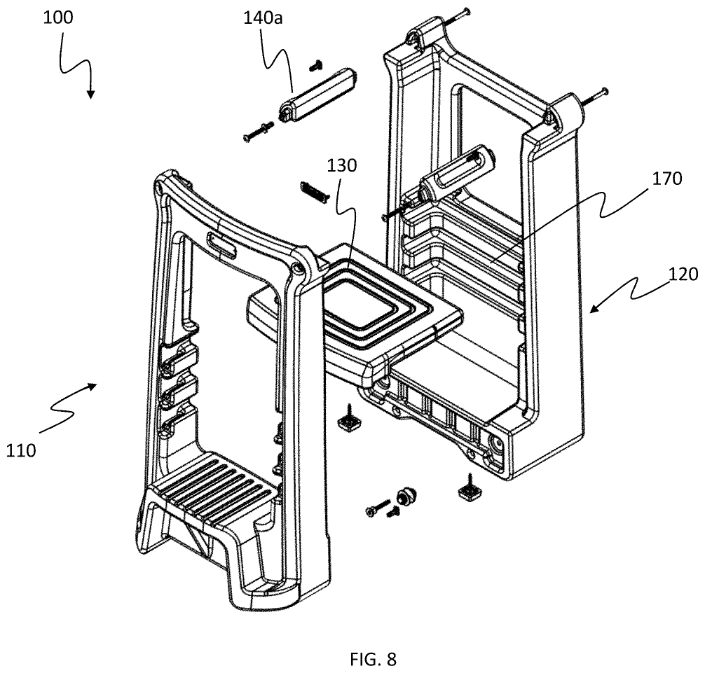

In embodiments with two or more connecting pieces, the pieces may be connected by bolts and screws. In one embodiment, provided by means of example and as depicted in FIG. 13, the pieces may be connecting with four 1¾′ (4.45 cm) threaded bolts, two 3″ (7.62 cm) threaded bolts, two washers, six threaded sleeve nuts, and two 1½′ (3.81 cm) threaded screws. Now referring to FIG. 8, the bottom portion may be connected in a similar manner as the top portion of the stool. Similar and other connecting means may be utilized, as may be anticipated by one skilled in the art.

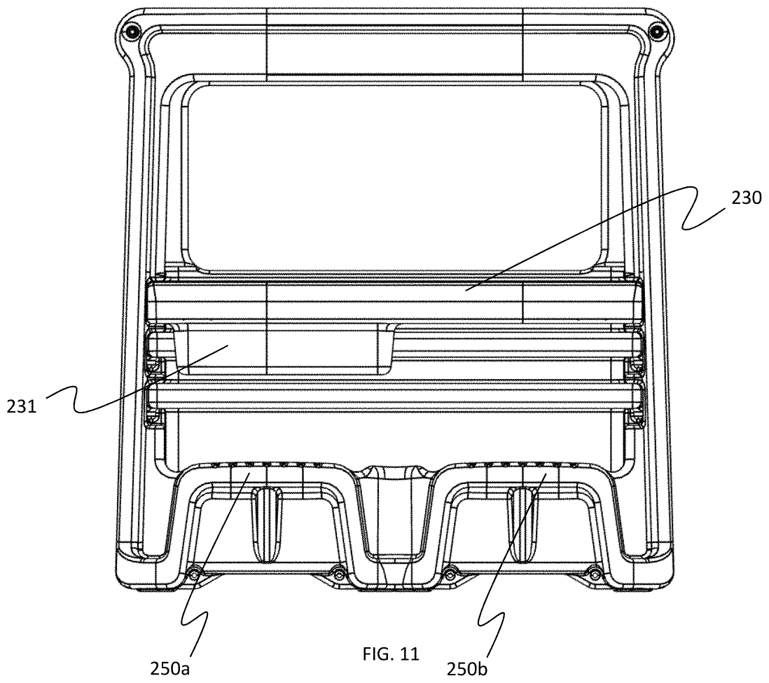

The stool may accommodate one user, or it may be adapted to accommodate two users. In some embodiments, the stool utilizes a selectively movable standing platform to lock the stool in place at various heights in order to accommodate differently sized children and counters or other structures of varying heights with which a child seeks to engage. In some embodiments, by way of example and as depicted in FIG. 11, the footstool may adjust between 12″ (30.48 cm), 15″ (38.1 cm), and 18″ (45.72 cm) of elevation from the surface upon which the stool is placed. In some embodiments, the platform may be used to elevate a user to standard 36″ (91.44 cm) counter height and 30″ (76.2 cm) table heights. In the same or other embodiments, the platform may flip, or reverse sides. Such platform may be referred to as a reversible platform or a flip platform. In such embodiments, or in embodiments without a reversible platform, the platform may on one or both sides feature platforms of varying heights, so as to accommodate children of different heights, as depicted in FIG. 15. The platform may be fully reversible and rotatable, so that the shorter platform may be on the left side of the stool, as seen from the front, and the taller platform on the right side, or vice versa. The design thus is very adjustable for differently sized children participating in a variety of activities. In some embodiments, one side may have platforms of various heights, while the other side has a platform of one, uniform height across the width of the platform. In other embodiments, both sides of the platform might be the same level across the width. In yet another embodiment, the platform has on one side two varying height platforms, and on the other side also two varying heights, preferably two different heights, thus accommodating even greater variation in the height of users.

In an example embodiment, the platform may slide into place, fitting into indentations, also known as hollow indentations, or rails in the front and back sections. The indentations or rails do not extend through the walls of the front and back sections. They are formed as cavities or indentations in the main body of the stool, either the front and back sections or the side walls of the front and back sections into which a platform may be inserted. The edges of the platform are shaped to fit into the indentations, as shown in the figures. In some embodiments, the platform may have a slide-down locking mechanism. In still other embodiments, the platform may be clipped or latched into place. Any engagement element or locking element that facilitates selective engagement may be employed. As seen in the figures, the platform securing mechanisms are not visible or accessible from the outside of the stool. This design serves as a means to aid in the prevention of injury that might be caused by the platform and stool in the absence of such measures, such as by pinching, cutting, or crushing of body parts such as fingers or hands. The sheltered design shields body parts from the platform mechanism while it is being locked in place. Additionally, the sheltered design helps prevent accidental movement of the platform, which could potentially upset users of the stool and/or cause injury.

In some embodiments, the stool requires very little assembly. The low assembly is desirable for ease, increased enjoyment and decreased frustration, quick play after a gift is presented, those with limited access to tools, and for adults and children with limited mobility or decreased fine motor skills. In some embodiments, the stool requires a moderate amount of assembly, and necessary bolts, screws and washers are provided. In some embodiments, the stool requires a high degree of assembly and has many pieces. In some embodiments, the stool may be assembled in about 5 minutes. In other embodiments, the stool may be assembled in less than 5 minutes.

In some embodiments, the stool may include one or more handles or regions for grasping so that the stool may be moved about a room, between rooms, or otherwise transported. The handles may be semi-circular in shape, be an indentation, or otherwise may be generally any other shape that facilitates easy manipulation of the stool. They may be attached or molded into the stool. The one or more handles may be configured to allow one or more children to lift and transport the stool unaided by adults.

In some embodiments, the stool is lightweight, such as under approximately 20 lbs (9 kg). In some embodiments, the stool is light enough for a small child or an individual lacking strength to push unaided. In one embodiment, the stool is approximately 13.2 lbs or approximately 6 kg. In some embodiments the stool is less than 15 lbs, or less than 16 lbs, or less than 17 lbs, or less than 18 lbs, or less than 20 lbs, or less than 14 lbs or less than 13.5 lbs. In some embodiments, the stool has a low profile that facilitates easy storage, for example, storage under a kitchen island, bar, or other raised counter surface. In one embodiment, the stool is approximately 34.5 inches or approximately 87.6 cm in height. In one embodiment, the stool is about 18 inches wide, as measured from the right and left sides, or about 46 cm wide, and about 16.5 inches deep, as measured from the front to back sides, or about 42 cm. In another embodiment, the stool is about 36 inches wide, or about 91 cm. In some embodiments, the stool is suitable for all ages. In some embodiments, the stool is suitable or recommended for ages 1.5 to 5 years old. In some embodiments, the stool is recommended or designed to bear a load, such as a person or persons, that is under 150 lbs (68 kg). In some embodiments, the stool is recommended or designed to bear a load under 60 lbs (27.2 kg).

In some embodiments, the stool is easy to clean, such as with, as a non-limiting example, mild soapy water. In some or other embodiments, the stool largely repels water, and is thus well adapted for use near water, such as in a bathroom or kitchen.

In some embodiments, the stool is constructed from rotationally molded, blow molded or injection molded plastic that includes strengthening ribs or areas of reinforcement. Strengthening ribs may be placed, for example, in the platform to help prevent undesirably bending and to allow the stool to support additional weight. The strengthening ribs may protrude downwardly from the underside of the platform, or may be housed within the plastic.

Stools of the present disclosure may have blunt edges, so as to prevent injury. Children, and people in general, are often falling over and otherwise striking objects. Stools and learning towers of the prior art frequently feature hard, pointed edges and corners, posing a risk of injury. Embodiments of the present disclosure have smoothened edges, and thus can help prevent injury. Stools are often used in bathrooms and kitchens, rooms where water is commonly found and therefore the chance of slipping and falling is heightened. A blunt edge is thus an important safety feature.

In other embodiments, the stool is adapted with non-skid rubber stoppers, rubber pads, or other non-skid material to secure the base and prevent the stool from sliding. In some embodiments, these non-skid elements are added to the step portion of the stool, or the platform. In one or more embodiments, the stool is designed for the child to stand in the center of the platform. In some embodiments, the stool features rounded edges as an additional safety measure to prevent injuries when the edges are impacted forcefully. In some embodiments, the stool is exceptionally durable, and can withstand vigorous and frequent activity by families, preschools, childcare centers, and other areas frequented by children.

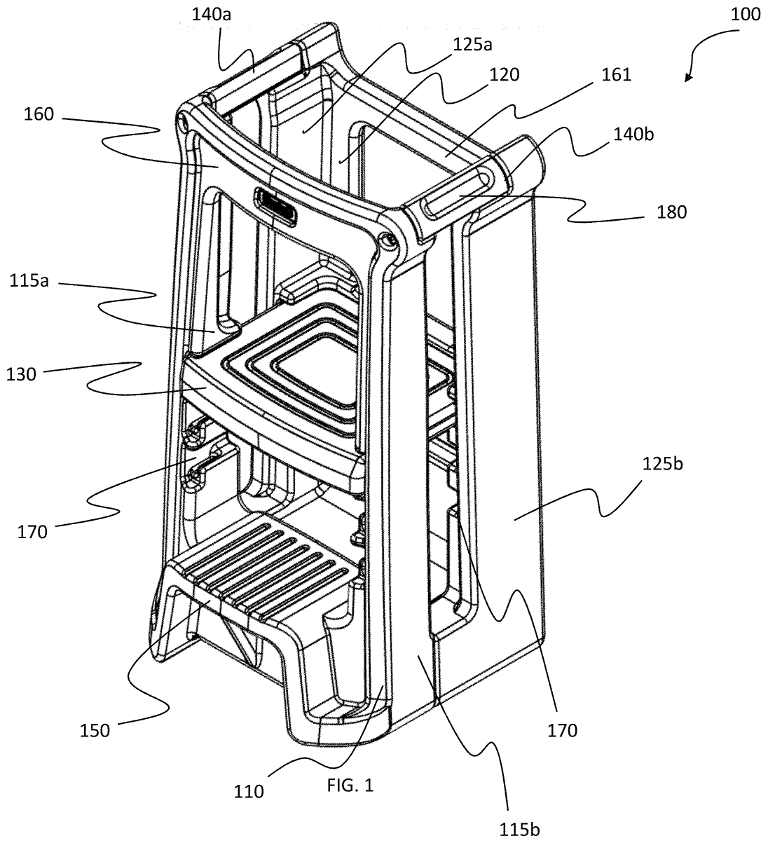

Turning now to the figures, FIG. 1 is a perspective view of a single user stool 100 with a front section 110 and a back section 120. Situated between the front and back section on indentations or rails 170 is a platform 130. Users may access the platform 130 by stepping onto a step 150 and ducking under the top bar or top rail 160. The top rail 160 prevents a user from falling backwards, while the back top bar or rail 161 prevents the user from falling forward. Two arms on either side 140a,b prevent a user from falling sideways, and also feature indentations or handles 180 which allow the user to grip the stool better when standing on it or when moving the stool. The handles may also be situated differently in other embodiments. The indentations or rails 170 upon which the platform 130 rests are formed into the front side walls 115a,b and the back side walls 125a,b which are the portions of the front section 110 and back section 120 that protrude to the side of the stool 100.

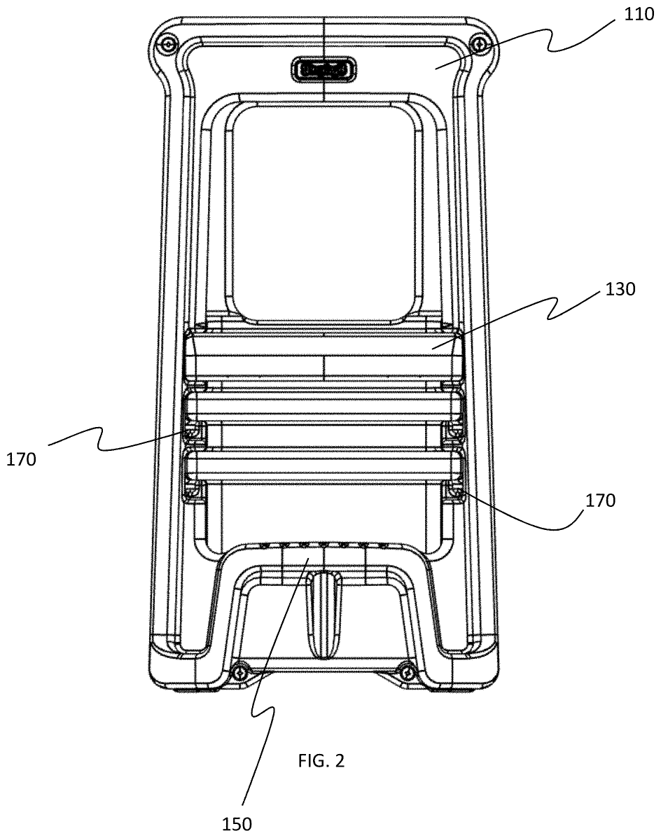

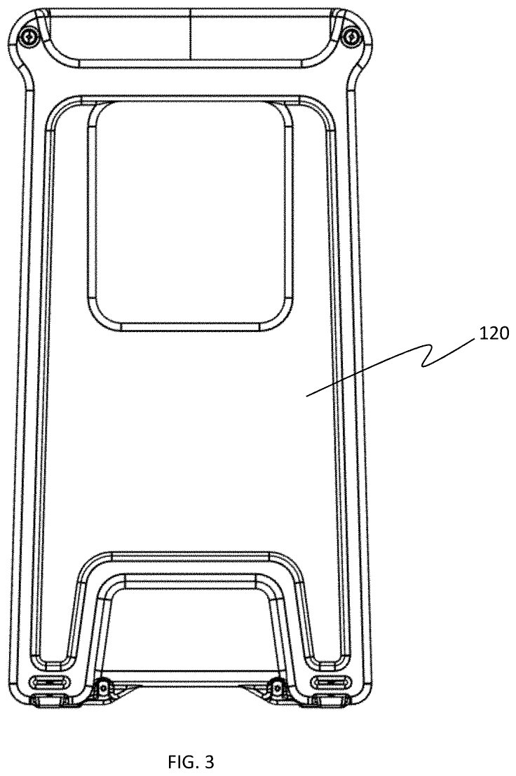

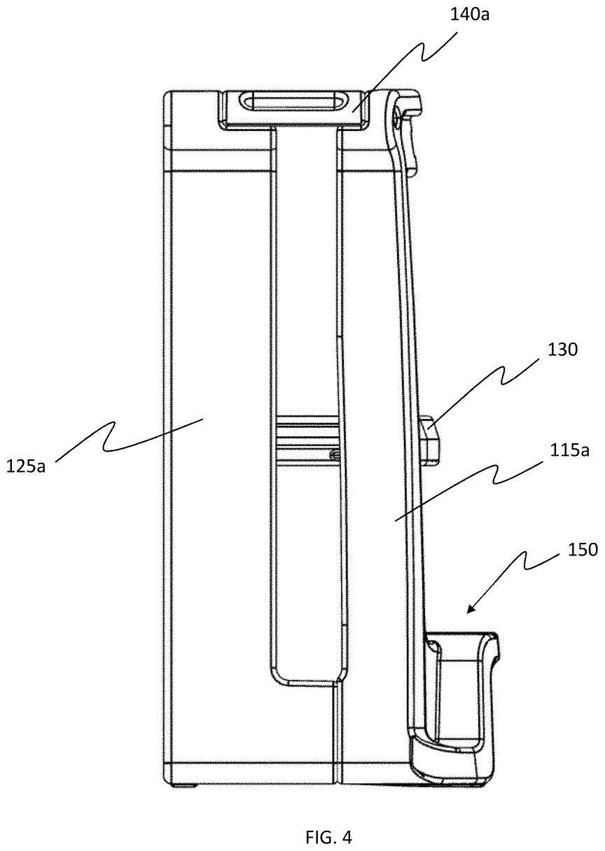

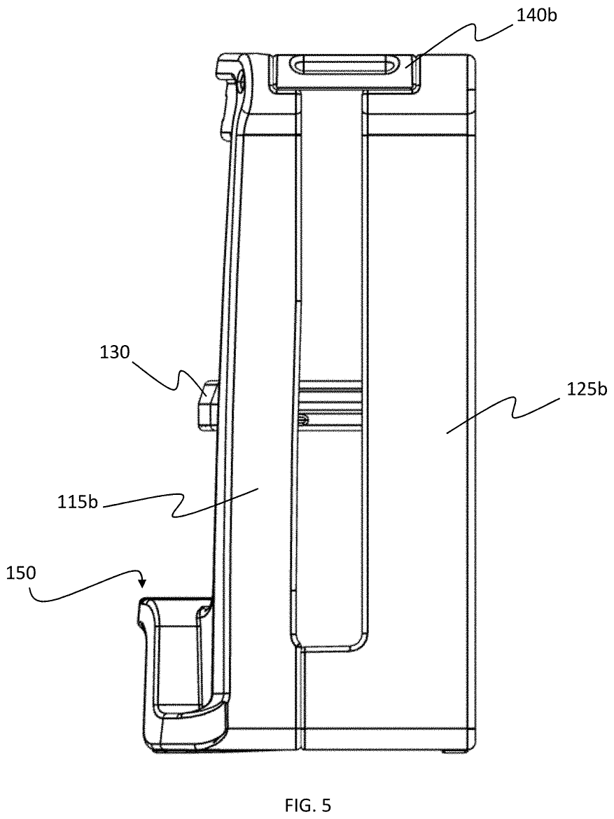

FIG. 2 is a front view of a single user stool. This view displays the front section 110 of the stool, with a step up to the platform. FIG. 3 is a back view of a single user stool. This view displays the back section 120 of the stool. FIG. 4 is a left side view of a single user stool, showing the left arm 140a, while FIG. 5 is a right side view of a single user stool showing the right arm 140b.

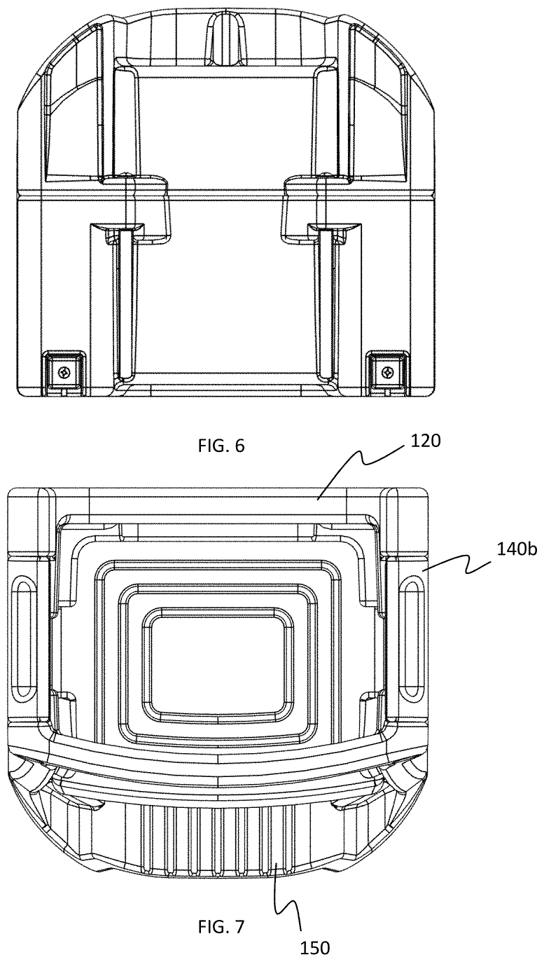

FIG. 6 is a bottom view of a single user stool, which is a view of the stool from the ground, while FIG. 7 is a top view of a single user stool.

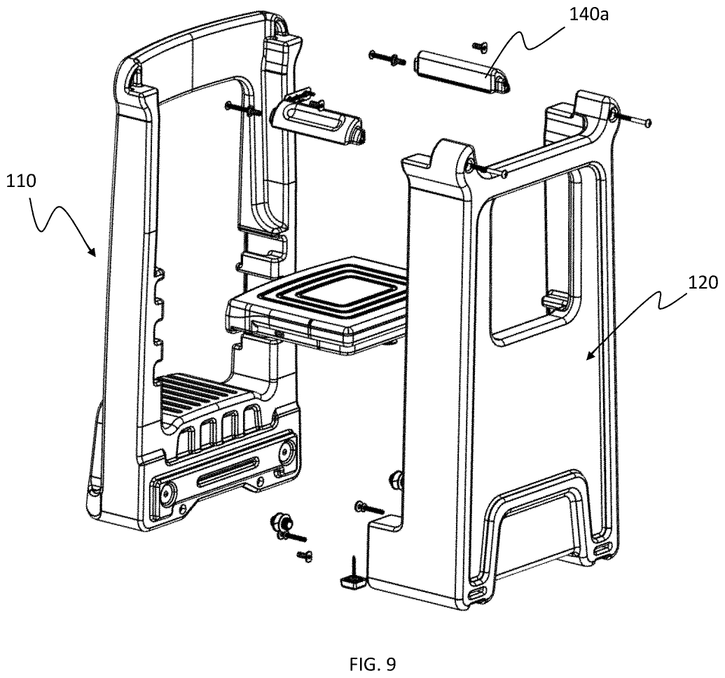

FIG. 8 and FIG. 9 are exploded views of a single user stool from the front and back perspective, respectively.

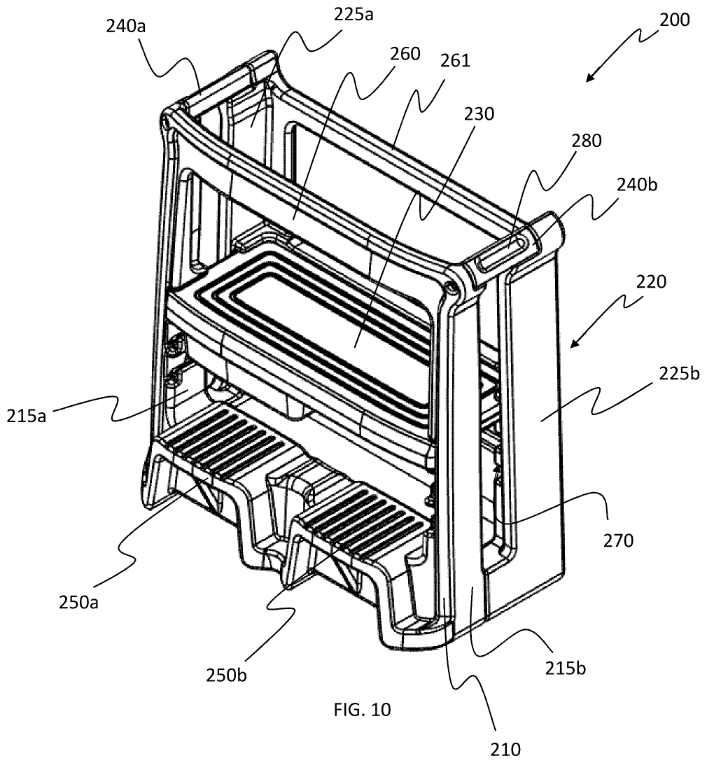

FIG. 10 is a front perspective view of a multi-user stool 200 with a flip platform 230 situated between the front section 210 and the back section 220 on indentations or rails 270. Users may access the platform by stepping onto a step 250 and ducking under the top bar or top rail 260. There is also a back rail 261. Users may move from the left side to the right side of the stool freely. Two arms on either side of the stool 240a,b prevent users from falling on the side, and provide a space to rest arms, grip, or situate a handle 280. The platform rests on rides or rails 270 formed into the front side walls 215a,b and back side walls 225a,b where the portions of the front section 210 and the back section 220 protrude on the sides of the stool 200. The platform has a protruding section 231 which raises the user higher than the flatter portion of the platform 230.

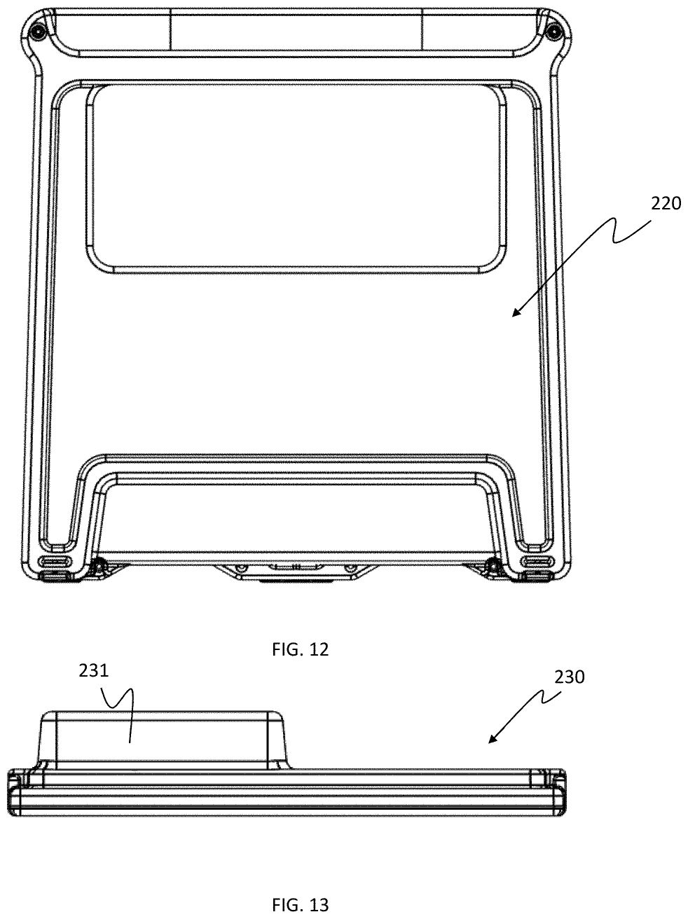

FIG. 11 is a front view of a multi-user embodiment with a flip platform. This view displays the front section 210 of the stool. FIG. 12 is a back view of a multi-user embodiment with a flip platform, and displays the back section 220 of the stool.

FIG. 13 is a front view of a flip platform, showing the varying height of the platform.

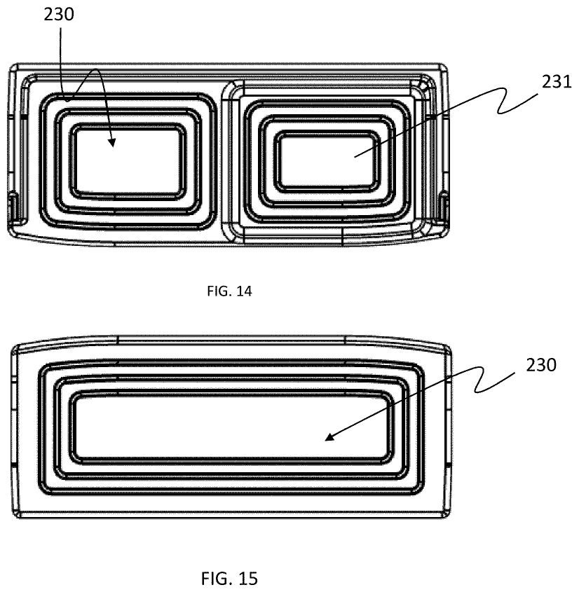

FIGS. 14 and 15 show overhead views of both sides of a flip platform.

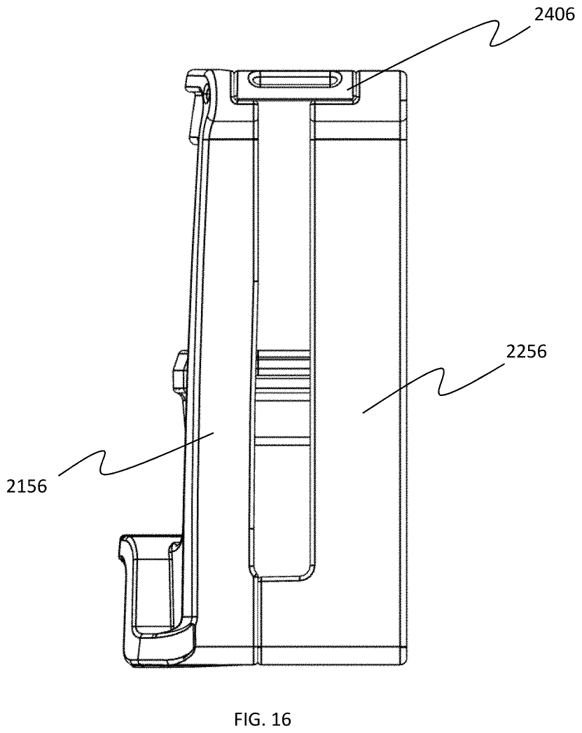

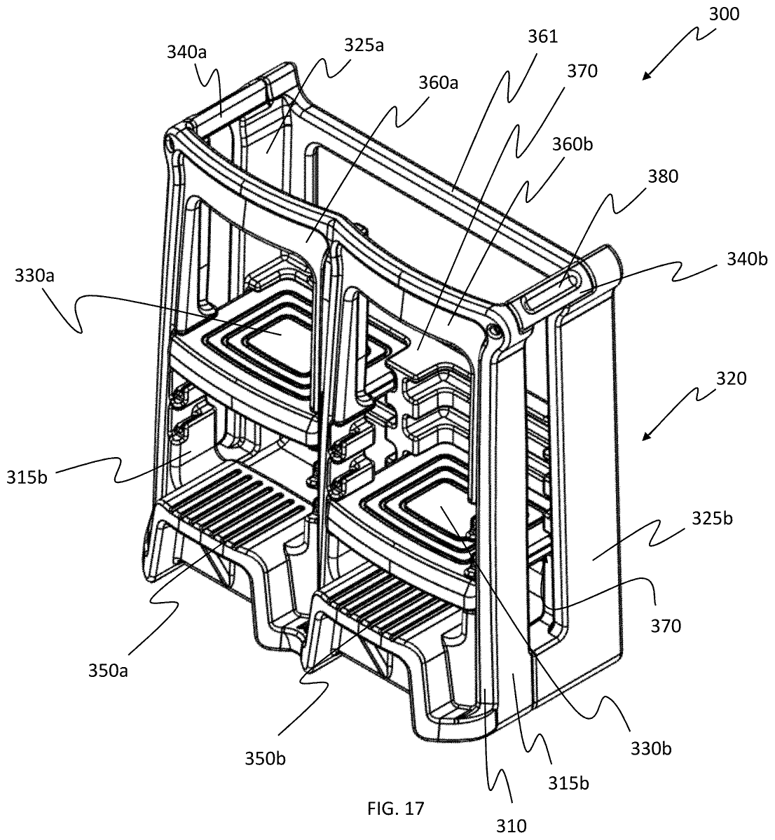

FIG. 16 is a side view of a multi-user embodiment with a flip platform showing the increased height of the platform from the side.

FIG. 17 is a front perspective view of a multi-user embodiment with individual platforms 300. This embodiment has two platforms 330a,b and two separate top rails 360a,b, separated by a center column 390. The center column has indentations or rails 370 just as the front side wall 315a,b and back side wall 325a,b of the front section 310 and back section 320 have. There is also a back rail, 361, and side arms 340a,b which prevent users from exiting the bounds of the stool. Handles 380 are also provided.

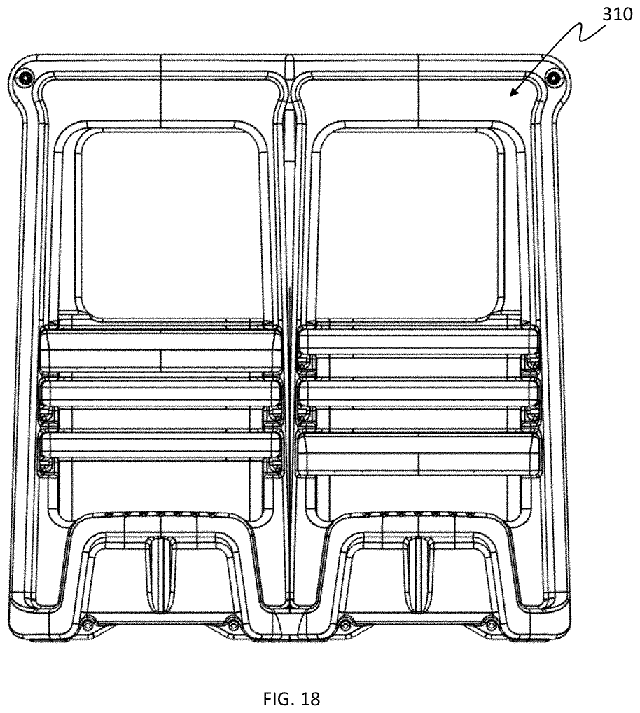

FIG. 18 is a front view of a multi-user embodiment with individual platforms.

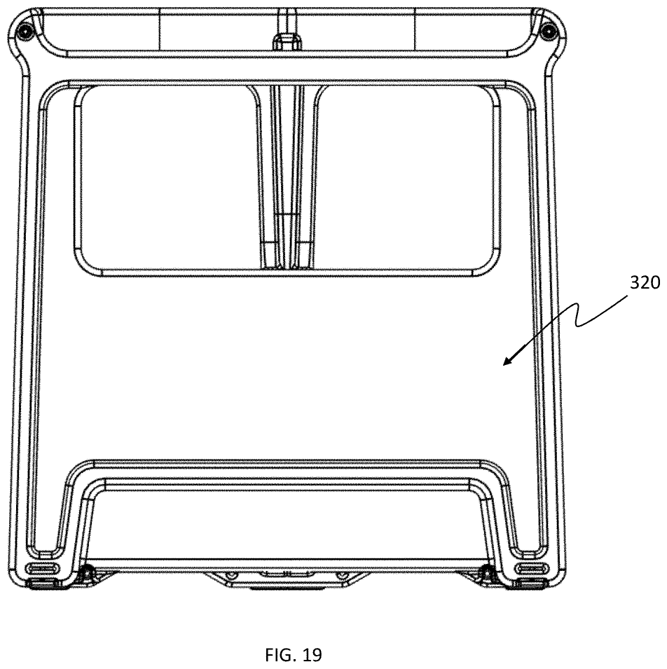

FIG. 19 is a back view of a multi-user embodiment with individual platforms.

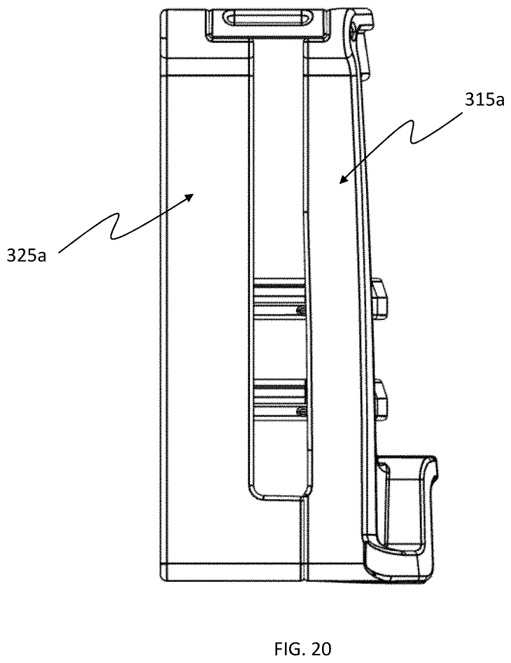

FIG. 20 is a side view of a multi-user embodiment with individual platforms.

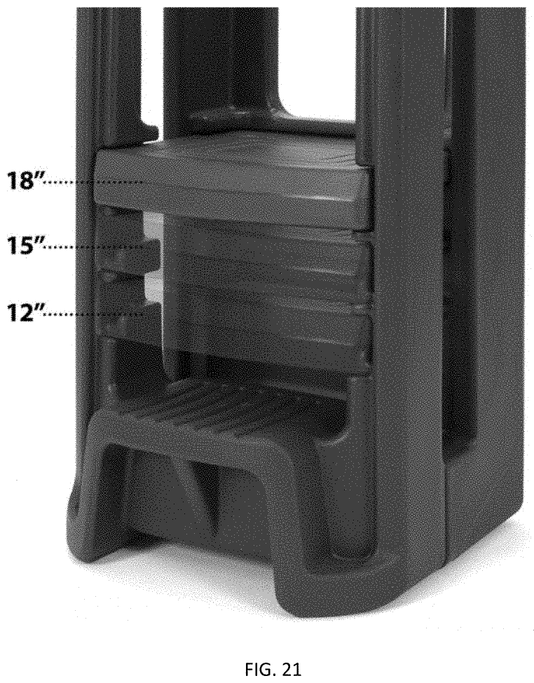

FIG. 21 is a view of a platform in one embodiment at various stages of adjustment, showing that the platform may be varying heights off of the ground.

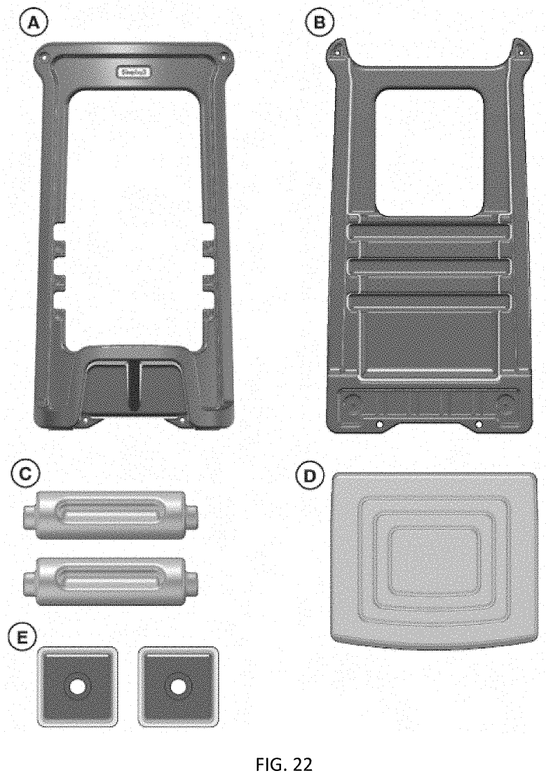

FIG. 22 shows parts of the stool in one embodiment. These parts may be assembled by the user before use.

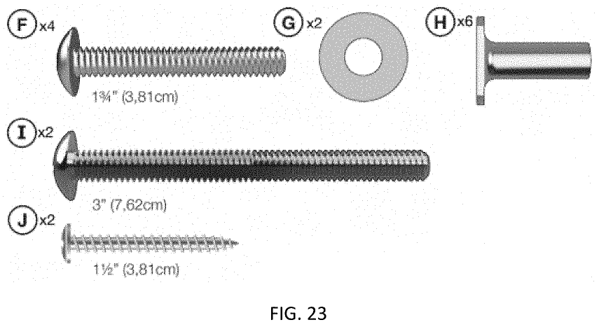

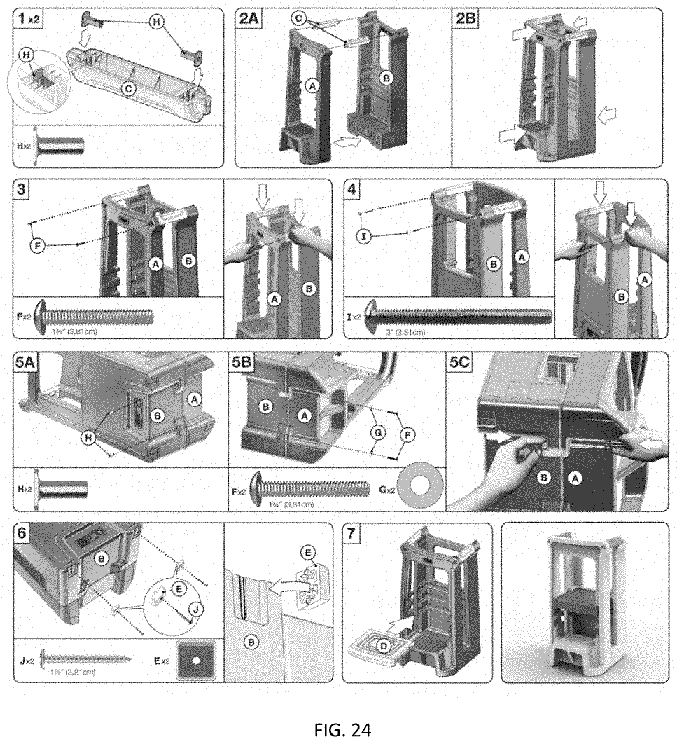

FIG. 23 shows hardware for use in the assembly of one embodiment of the stool. This hardware, in multiples as shown, may be used by an individual to assemble the stool, following the directions as provided and shown in FIG. 24.

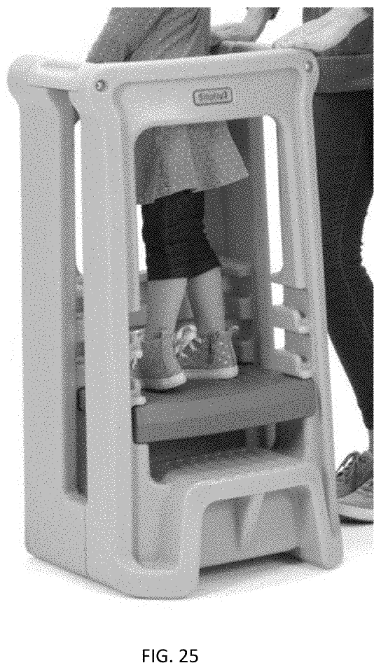

FIG. 25 is a perspective view of one embodiment of the stool showing how the stool is used.

From the above description, it will be readily apparent to those skilled in the art that the presently disclosed subject matter is an improvement u pon other adjustable stools for many reasons. Such reasons may include that the platform adjusting mechanism is shielded from view from the exterior of the stool, which prevents curious children from interacting with the adjusting mechanism, which may lead to injuries. Further, the stool contemplates further adjustment than previously available in the art by having a reversible platform with a flat side and one with a protruding side, so that the protruding side may be used to elevate a user more than is possible with a flat platform. Still further, two or more users are contemplated, and the presently disclosed adjustable platform may have a flat side and a side with about one half of the platform protruding to a greater degree than other half, which is flat, such that users may use the stool so that they are standing at the same elevation from the floor, or at different elevations from the floor. Also, the presently disclosed stools are capable of being lighter than stools known in the art, which is more useful for diminutive persons for whom the stool is designed, as they may be more easily moved. These and other innovations may be appreciated by one skilled in the art.

This invention has been described with reference to illustrative embodiments, and is not meant to be construed in a limiting sense. It will be apparent to one skilled in the art that elements or process steps from one or more embodiments described herein may be used in combination with elements or process steps from one or more other embodiments described herein, and that the present invention is not limited to the specific embodiments provided herein but only as set forth in the accompanying claims. Various modifications of the illustrative embodiments, as well as additional embodiments to the invention, will be apparent to persons skilled in the art upon reference to this description.

What is claimed is:

1. A stool comprising:
a platform; and
a pair of vertically extending walls with blunt edges, each of the vertically extending walls having integral side walls and two or more hollow indentations extending partway through the vertically extending walls;
wherein the platform transversely extends between the integral side walls of the pair of vertically extending walls, and is adjustably supported by at least one of the two or more hollow indentations of each vertically extending wall.

2. The stool of claim 1, wherein the pair of vertically extending walls each further comprise a rail enclosing a space defined over the platform and between the vertically extending side walls to prevent a user from falling.

3. The stool of claim 1, further comprising a step integrated into one or more of the vertically extending walls.

4. The stool of claim 1, wherein the stool weighs less than 15 lbs.

5. The stool of claim 1, wherein at least one of the pair of vertically extending walls further comprises one or more handles.

6. The stool of claim 3, further comprising a non-skid material disposed on one or more surfaces of the stool to prevent slipping or sliding.

7. The stool of claim 1, wherein the platform further comprises two reversible sides, with one of the reversible sides having a greater height than the other side.

8. A multi-user stool comprising:
a wide platform suitable for holding two or more users; and
a pair of vertically extending walls with blunt edges, each of the vertically extending walls having integral side walls and two or more hollow indentations extending partway through the vertically extending walls;
wherein the wide platform transversely extends between the integral side walls of the pair of vertically extending walls, and wherein the vertically extending walls adjustably support the wide platform.

9. The multi-user stool of claim 8, wherein the wide platform further comprises two reversible sides, wherein one of the reversible sides has a uniform height along the length of the wide platform, and one of the reversible sides has two different heights along the length of the wide platform.

10. The multi-user stool of claim 8, wherein the wide platform is adjustably supported by at least one of the two or more hollow indentations in each of the vertically extending walls.

11. The multi-user stool of claim 8, wherein the pair of vertically extending walls each further comprise a rail enclosing a space defined over the platform and between the vertically extending side walls to prevent a user from falling.

12. The multi-user stool of claim 8, further comprising a step integrated into one or more of the vertically extending walls.

13. The multi-user stool of claim 8, wherein at least one of the pair of vertically extending walls further comprises one or more handles.

14. The multi-user stool of claim 8, further comprising a non-skid material disposed on one or more surfaces of the stool to prevent slipping or sliding.

15. A multi-user stool comprising:
two platforms; and
a pair of vertically extending walls with blunt edges, each of the vertically extending walls further comprising: integral side walls, an integrated center column, and two or more hollow indentations extending partway through the vertically extending wall;
wherein each platform transversely extends between the integral side walls and the integrated center column, and wherein at least one of the platforms is adjustably supported by one of the two or more hollow indentations of each vertically extending wall.

16. The multi-user stool of claim 15, wherein the pair of vertically extending walls each further comprise a rail enclosing a space defined over the platform and between the vertically extending side walls to prevent a user from falling.

17. The multi-user stool of claim 15, further comprising a step integrated into one or more of the vertically extending walls.

18. The multi-user stool of claim 15, wherein at least one of the pair of vertically extending walls further comprises one or more handles.

19. The multi-user stool of claim 15, further comprising a non-skid material disposed on one or more surfaces of the stool to prevent slipping or sliding.
